(19) United States
(12) Patent Application Publication
(10) Pub. No.: US 2012/0176769 A1
(43) Pub. Date: Jul. 12, 2012

(54) ILLUMINATION DEVICE AND MEDICAL-OPTICAL OBSERVATION INSTRUMENT

(75) Inventors: Peter Reimer, Ellwangen (DE); Markus Bausewein, Aalen (DE)

(73) Assignee: Carl Zeiss Meditec AG, Jena (DE)

(21) Appl. No.: 13/376,997

(22) PCT Filed: Jun. 8, 2010
(86) PCT No.: PCT/EP2010/003746

§ 371 Date: Mar. 28, 2012

(30) Foreign Application Priority Data
Jun. 9, 2009 (DE) 10 2009 024 941.9

(51) Int. Cl. F21V 13/08; F21V 13/02; F21V 9/16

(52) U.S. Cl. 362/84

(57) ABSTRACT

An illumination device for a medical-optical monitoring apparatus illuminates a monitored object (7) with illumination light via an illumination beam path (90). The illumination device has at least one luminescence emitter (77) as a light source as well as at least one converter element (97-102) separated from the luminescence emitter (77), is provided with a converter luminescent substance for converting at least some of the wavelength distribution of the light emitted by the at least one luminescence emitter (77). The converter element is or can be introduced into the illumination beam path (90).

### BACKGROUND OF THE INVENTION

1. Field of the Invention

The present invention relates to an illumination device for a medical-optical observation instrument for observing an observation object.

2. Description of the Related Art

In order to impart a color impression that is as natural as possible, medical-optical observation instruments such as endoscopes or surgical microscopes are equipped with white-light sources, the color temperature of which corresponds to that of daylight and has a correspondingly large blue component. In some systems, e.g. in ophthalmological surgical microscopes, a white light with a smaller blue component may additionally be desired. In the case of cataract operations in particular, in which the lens of the eye is removed, white light comprising a smaller blue component is able to produce a so-called red reflex in a particularly good fashion, the latter being used to illuminate the lens during the cataract operation. This red reflex is created as a result of reddish to orange reflection of the illumination light on the retina. It is therefore advantageous if the light has a larger red component; this is all the more the case the lower the color temperature is. Surgical microscopes which have been adapted to the generation of a red reflex are for example described in DE 10 2007 041 003 A1, DE 10 2007 008 635 A1, DE 10 2006 013 761 A1, DE 10 2004 050 651 A1 and DE 103 47 732 A1. The red background illumination generated by the red reflex thereby allows the operator to identify the details relevant to the cataract operation. There additionally also is illumination of the surroundings in order to illuminate the surgical area sufficiently. Here, the white light from the illumination of the surroundings can also differ from the white light of the red-reflex illumination in terms of its color temperature.

While the red-reflex illumination is often coaxial or virtually coaxial to the stereoscopic observation beam paths in a surgical microscope, the illumination of the surroundings is generally abaxial, i.e. both at an angle to the optical axes of the stereoscopic partial observation beam paths and generally also at an angle to the optical axis of the microscope main objective.

An illumination device for a surgical microscope to be used for cataract operations is described in detail in e.g. DE 10 2007 041 003 A1. Therein, the illumination systems in the surgical microscope are spliced from a halogen or xenon light source over spliced optical waveguides. However, this does not allow independent regulation of the coaxial illumination and illumination of the surroundings illumination types. Although separate regulation is possible in principle if a plurality of optical waveguides are used, this increases the complexity of the illumination system.

DE 20 2004 019 849 U1 and EP 0 661 020 A1 have moreover disclosed illumination devices that provide separate light sources for the red-reflex illumination and the illumination of the surroundings. DE 20 2004 019 849 U1 moreover mentions that light-emitting diodes may be used as a light source. However, as a result of using separate light sources for the red-reflex illumination and the illumination of the surroundings, an increased amount of space is required.

Thus, compared to the cited prior art, an object of the present invention may be considered to be the provision of an advantageous illumination device for a medical-optical observation instrument, which can be used in an advantageous fashion, particularly in the case of ophthalmological surgical microscopes.

A further object of the present invention is to provide an advantageous medical-optical observation instrument.

### SUMMARY OF THE INVENTION

An illumination device according to the invention for a medical-optical observation instrument, for example a surgical microscope and more particularly an ophthalmological surgical microscope, for illuminating an observation object with illumination light via an illumination beam path comprises at least one luminescence emitter as a light source. Examples of luminescence emitters are light-emitting diodes (LEDs), organic light-emitting diodes (OLEDs), laser (diodes), and also electroluminescent films, if these can achieve a sufficiently high luminous intensity. Here, illumination light should not be considered to be restricted to light in the visible spectral range but it should also include light in adjacent spectral ranges, i.e. also in the ultraviolet spectral range and in the infrared spectral range. The illumination device according to the invention furthermore comprises at least one converter element, which is arranged separately from the luminescence emitter and provided with a converter phosphor for converting at least part of the wavelength distribution of the light emitted by the at least one luminescence emitter. The converter element is or can be introduced into the illumination beam path.

Compared to incandescent lamps or gas-discharge lamps, light-emitting diodes have smaller dimensions, as a result of which it is possible to provide separate light sources, for example for red-reflex illumination and illumination of the surroundings, in an illumination device without this necessarily leading to a significant increase in the installation size of the illumination device compared to an illumination device with only one light source. As a result of this, it is possible to dispense with using a complicated optical waveguide, e.g. a spliced optical waveguide, even if only little installation space is available. More particularly, the light-emitting diode can be a narrow-band light-emitting diode, for example a blue light-emitting diode.

In the illumination device according to the invention for a medical-optical observation instrument, a move is made away from using a white-light source as a primary light source. Instead, use is made of a typically narrow-band light emitting luminescence emitter, e.g. a light-emitting diode, as a light source. Then, the narrow-band light is converted into white light or another broad-band light once it is in the illumination beam path. To this end, the converter phosphor of the converter element converts at least a portion of the narrow-band light into light with a longer wavelength than that of the original narrow-band light. As a result of the fact that part of the light emitted by the light-emitting diode is converted into longer wavelength light by means of the converter phosphor, there is a superposition in the illumination beam path of the converted light on the remainder of the original, unconverted light, leading to a broad-band wavelength distribution, more particularly to white light. By way of example, this makes it possible to make use of a light-emitting diode emitting blue light. In order to produce e.g. white light, the converter phosphor can then be selected such that it converts part of the blue light into yellow and/or green and/or red light such that the superposition of the yellow light on the remaining blue light results in white light. By contrast, if e.g. use is made of a light-emitting diode emitting UV radiation, it is possible to convert the UV radiation completely into light in the visible spectral range by means of a converter phosphor. Moreover, it is possible to convert the UV radiation completely into light with at least two wavelength distributions, which in sum lead to broad-band or white light, by using a plurality of converter elements that, in succession, are arranged in the illumination beam path or can be introduced into the illumination beam path, which converter elements have different converter phosphors, or by using a converter element with a converter phosphor that is a mixture of different phosphors. However, the use of converter elements that, in succession, are arranged in the illumination beam path or can be introduced into the illumination beam path, which converter elements have different converter phosphors, or by using a converter element with a converter phosphor that is a mixture of different phosphors, for implementing a white or broad-band illumination light is possible not only when using an LED emitting in the UV range, but also when using an LED emitting in the visible spectral range.

Arranging the converter material spatially separately from the luminescence emitter offers the option of influencing the wavelength distribution of the light, routed to the object via the observation beam path, in a simple fashion by interchanging the converter material. In particular, this results in the possibility of producing light with different color temperatures in a largely lossless fashion compared to using absorption filters. Here, light with different color temperatures is produced using different converters, which differ from one another in terms of the converter phosphors. As a result of little light being absorbed or reflected in the converter, the light rather being converted in terms of its wavelength, there is no generation of unnecessary thermal losses or reflection losses like in conventional illumination devices, in which use is made of absorption filters or interference filters for converting the color temperature.

Furthermore, the option of replacing optical fiber ends by light-emitting diodes is advantageous in that, unlike in the case of spliced optical waveguides, the light from different illumination types, for example the light for red-reflex illumination and illumination of the surroundings, can be set independently from one another in terms of its intensity. By contrast, in the case of using a single light source and a spliced optical waveguide, the intensity is regulated by means of attenuator elements, which are generally embodied as stops, which in turn leads to heat development and thus leads to a destruction of light power.

An illumination device typically comprises a condenser optical system. The converter element then preferably is or can be introduced into the illumination beam path between the luminescence emitter and the condenser optical system. Furthermore, there may be a collector optical system between the condenser optical system and the luminescence emitter, as a result of which a Köhler optical system can be implemented. In the latter, the collector optical system images the light source in an intermediate image plane situated between the collector optical system and the condenser optical system. In such an illumination optical system, it is possible that the converter element is or can be introduced into the illumination beam path between the collector optical system and the condenser optical system.

Typically stops are also situated between the collector optical system and the condenser optical system, for example a radiant field stop and an aperture stop in the case of Köhler illumination. The converter element can then be part of a stop situated in the illumination beam path or part of a stop that can be introduced into the illumination beam path. Since the stop can then serve as a support of the converter element, there is no need for an additional component in the illumination beam path. In particular, it is possible that the converter element is or can be introduced into the illumination beam path in a plane conjugate to the object plane of the observation object. In the case of Köhler illumination, the radiant field stop is situated in this plane, and so the converter element can be part of the radiant field stop. Here the radiant field stop has the task of sharply delimiting the illuminated field in the object. Since it is situated in a conjugate plane to the object plane of the observation object, the edge of the stop is imaged in a sharply defined fashion on the object. At the same time, the radiant field stop is situated outside of the image plane in which the luminescence emitter is imaged by the collector optical system, and so there is a homogeneous illuminated field in the region of the radiant field stop. As a result, the converter is also illuminated in a homogeneous fashion, and so local saturations of the converter phosphor as a result of inhomogeneities in the illuminated field can largely be avoided. At the same time, the radiant field stop can serve as a support for the converter material.

As an alternative to being arranged in a plane conjugate to the object plane, it is also possible that the converter element is or can be introduced into the illumination beam path directly in front of or behind a plane conjugate to the object plane. As a result of the converter element being arranged in the direct vicinity of the conjugate plane, the advantages that can be achieved by being arranged directly in the conjugate plane are also realized to a great extent. On the other hand, it is then possible to replace the converter element without having to replace the radiant field stop at the same time. Changing the diameter of the radiant field stop is not hindered by the converter element either. By way of example, this renders it possible that the radiant field stop is embodied as an iris stop; this could only be implemented with difficulties in the case of a converter element integrated into the stop.

Instead of being in, or in the vicinity of, a plane conjugate to the object plane, it is also possible that the converter element is or can be introduced into the illumination beam path in a plane conjugate to the illuminated area of the luminescence emitter. Since there is an image of the illuminated area of the luminescence emitter in such a plane, a relatively small converter element is sufficient. In the case of Köhler illumination, the aperture stop is typically also situated in this plane, and so the converter element can be embodied as part of the aperture stop. However, it is also possible that the converter element is or can be introduced into the illumination beam path directly in front of or behind a plane conjugate to the illuminated area of the luminescence emitter. As a result, the advantages of being arranged directly in the conjugate plane can virtually be implemented without the independence of the aperture stop being adversely affected. Then it is possible for the converter element and opening of the aperture stop to be replaced or changed independently of one another.

In an alternative embodiment of the illumination device according to the invention, the converter element is or can be introduced into the illumination beam path between the luminescence emitter and the collector optical system. In particular, the converter element then is or can be introduced into the illumination beam path directly adjacent to the illuminated area of the luminescence emitter. In this case it is also possible to keep the dimensions of the converter element relatively small because they do not have to significantly exceed the dimensions of the illuminated area.

The converter element can have an entry area for the illumination light emitted by the luminescence emitter, which entry area faces the luminescence emitter and is provided with a dichroic layer that is transparent to unconverted light entering the converter element. By contrast, this dichroic layer is highly reflective for converted light directed in the direction of the luminescence emitter. This makes it possible to prevent converted light emerging from the converter element in the direction of the luminescence emitter and thus being lost for the illumination.

In a further embodiment, the illumination device according to the invention comprises at least two converter elements, which can be embodied as described above and which, individually or together, are or can be introduced into the illumination beam path. In particular, each of these converter elements can be arranged in or in the vicinity of one of the above-described conjugate planes or in the vicinity of the luminescence emitter. In this case in particular, it is possible to arrange two converter elements in or in the vicinity of the same plane. Alternatively, these can be arranged in or in the vicinity of different planes. By using at least two converter elements, four different wavelength distributions of the illumination light can be realized for one luminescence emitter. Using a larger number of converter elements makes it possible to further increase the number of different spectral distributions. However, there also is the option of arranging the converter elements such that in each case only one of the converter elements can be introduced into the illumination beam path. This can ensure that the converter phosphor is always situated at the same location in the illumination beam path.

Furthermore, according to a second aspect of the invention, at least one second luminescence emitter may be present, which can be introduced into the illumination beam path instead of the first luminescence emitter and the light of which has a spectral wavelength distribution that differs from the spectral wavelength distribution of the light emitted by the first luminescence emitter. By way of example, the first luminescence emitter can be a blue LED and the second luminescence emitter can be an LED emitting in the green spectral range. In this case, different spectral wavelength distributions can be implemented by interchanging the luminescence emitters rather than by means of converter elements. Then a converter element in the illumination beam path is no longer mandatory. However, if a converter element or a plurality of different converter elements can be introduced into the illumination beam path, this can realize a multiplicity of spectral wavelength distributions in the illumination light.

Although it has not been mentioned explicitly, the illumination device according to the invention may have at least two luminescence emitters that are or can be introduced into the illumination beam path at the same time, which luminescence emitters represent different light sources, for example a light source for the red-reflex illumination and a light source for the illumination of the surroundings or two separate light sources for the red-reflex illumination, namely one for an illumination beam path coaxial with the left stereoscopic observation beam path and one for an illumination beam path coaxial with the right stereoscopic observation beam path. It goes without saying that in the case of two separate luminescence emitters for the partial beam paths of a coaxial red-reflex illumination, there may be a third luminescence emitter for the illumination of the surroundings.

A medical-optical observation instrument according to the invention, which may be embodied e.g. as an endoscope or as a surgical microscope and more particularly as an ophthalmological surgical microscope, is equipped with an illumination device according to the invention. Hence the advantages described with reference to the illumination device also emerge in the medical-optical observation instrument according to the invention.

Further features, properties and advantages of the present invention emerge from the following description of exemplary embodiments with reference to the attached figures.

### BRIEF DESCRIPTION OF THE DRAWINGS

FIGS. 1 to 16 show exemplary embodiments for the illumination optical system according to the invention.

FIG. 17 shows, in a very schematic illustration and in a lateral view, a surgical microscope as an exemplary embodiment for the medical-optical observation instrument according to the invention.

FIG. 18 shows a plan view of the surgical microscope from FIG. 17.

### DETAILED DESCRIPTION OF THE PREFERRED EMBODIMENTS

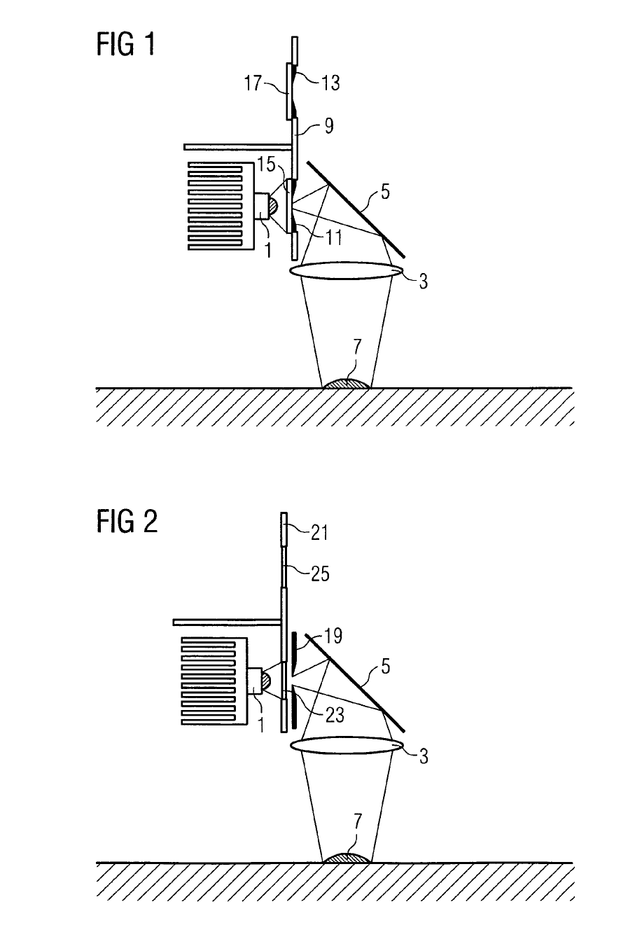

An illumination device according to the invention is shown in FIG. 1 in a greatly simplified illustration. The illumination device comprises a light-emitting diode 1 as a light source and a condenser optical system 3, with the aid of which the illumination is optimized for the observation. The condenser optical system 3 is illustrated schematically as a lens in FIGS. 1 to 16. However, in general it is composed of a plurality of lenses. If the illumination device is used together with a surgical microscope, the illumination beam path can, in principle, be routed past the main objective of the surgical microscope, or alternatively it can be routed through the main objective. If the illumination beam path is routed through the main objective, the main objective can be considered to be part of the condenser optical system of the illumination beam path. In this case, in addition to the optical components of the main objective, the condenser optical system comprises further optical components which are embodied such that, together with the main objective, they ensure optimum illumination of the observation object. In the following description of the exemplary embodiments of the illumination device, which is performed with reference to FIGS. 1 to 16, the condenser optical system 3 can thus also comprise the main objective of a surgical microscope if the illumination device is used in conjunction with a surgical microscope.

Moreover, a light-deflecting element 5 is arranged in all exemplary embodiments; it is used to deflect the illumination light in the direction of the observation object 7. Although the light-deflecting element 5 is arranged between the light source 1 and the condenser optical system 3 in the exemplary embodiments, the condenser optical system 3 can also be arranged between the light source 1 and the light-deflecting element 5. Moreover, the light-deflecting element 5 can be a beamsplitter, for example a partly transparent mirror, if the illumination beam path is routed through the main objective of a surgical microscope. In this case there is the option of arranging the light-deflecting element 5 in the observation beam path such that the illumination light can be coaxially superposed on the stereoscopic partial observation beam paths of the surgical microscope.

In the exemplary embodiment illustrated in FIG. 1, there is a stop wheel 9 with at least two stops 11, 13, which can alternately be introduced into the illumination beam path. The stops 11, 13 can have the same stop diameter, or else they can have different stop diameters. Converter elements 15, 17 are arranged on both stops 11, 13. The two converter elements 15, 17 differ in terms of their converter phosphors. Instead of being arranged directly in front of the radiant field stops 11, 13, as shown in FIG. 1, the converter elements 15, 17 can also be arranged directly in the stop opening.

The light-emitting diode 1 used in the present exemplary embodiment emits narrow-band light, part of which is converted into green light and/or yellow light and/or red light, i.e. into light with a longer wavelength, by means of the converter phosphor. The superposition of the blue initial light and the converted light then leads to a broad or white spectral wavelength distribution. A suitable selection of the phosphors thus allows wavelength distributions with different spectral widths to be realized, for example to allow illumination with different color temperatures.

In the second exemplary embodiment, shown in FIG. 2, use is also made of a narrow-band blue light emitting light-emitting diode 1 as a luminescence emitter. However, like in all other exemplary embodiments, use can also be made of a different type of luminescence emitter, for example an organic light-emitting diode or, provided that the luminous intensity is sufficient, an electroluminescent film. The luminescence emitter likewise need not emit blue light. Rather, it can also emit in a different spectral wavelength range that permits converting at least part of the light into light with a longer wavelength.

In contrast to the exemplary embodiment illustrated in FIG. 1, there is a fixed stop 19 in the exemplary embodiment shown in FIG. 2, with a converter-element wheel 21 with at least two different converter elements 23, 25 being arranged upstream of said fixed stop on the light-source side. Rotating the converter-element wheel 21 thus allows different converter elements 23, 25 to be alternately introduced into the illumination beam path in order to allow illumination with different spectral wavelength distributions.

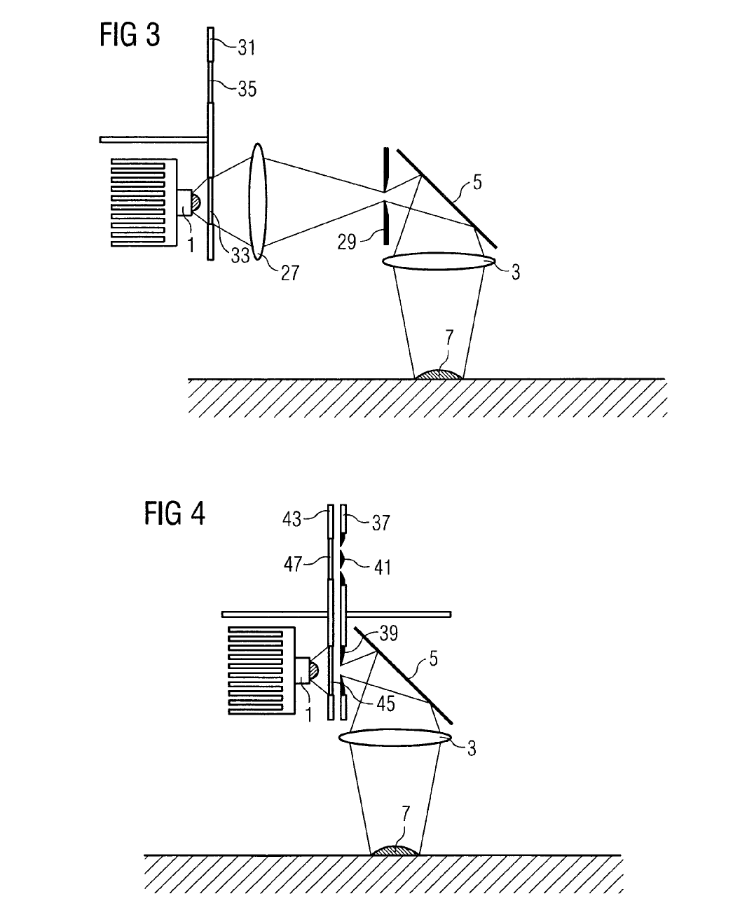

FIG. 3 shows a third exemplary embodiment of the illumination device according to the invention, in which there is an illumination beam path with an intermediate image. A collector optical system 27 which generates an intermediate image of the light-emitting diode 1 is present in such an illumination device between the light source 1, which once again is a narrow- band light-emitting diode, and the condenser optical system 3. There is an aperture stop 29 at the location of the intermediate image and it allows the brightness of the illumination to be set. In the exemplary embodiment shown in FIG. 3, there is a converter-element wheel 31 between the light-emitting diode 1 and the collector optical system 27, and it has at least two different converter elements 33, 35 which can alternately be introduced into the illumination beam path.

Analogously to the condenser optical system 3, the collector optical system 27 is illustrated merely as a lens for simplicity. However, in general it comprises a plurality of optical elements for increasing the imaging quality of the collector optical system 27. It goes without saying that this also holds true for all other exemplary embodiments in which the collector optical system is merely illustrated as a single lens.

A fourth exemplary embodiment of the illumination device according to the invention is illustrated in FIG. 4. This exemplary embodiment constitutes a combination of the exemplary embodiments from FIGS. 1 and 2. Like in the exemplary embodiment illustrated in FIG. 1, there is a stop wheel 37 with at least two different stops 39, 41 that can penetrate the illumination beam path. In the present exemplary embodiment, there is at least one single stop 39 and a double stop 41. Here, the double stop 41 serves to implement a coaxial illumination beam path by coaxially superposing two partial beam paths of the illumination on the stereoscopic partial observation beam paths of a surgical microscope.

However, in contrast to the exemplary embodiment illustrated in FIG. 1, the converter elements are not arranged directly on the stops; rather, they are on their own converter-element wheel 43. Said wheel comprises at least two converter elements 45, 47, which differ from one another in terms of their converter phosphors. The converter elements 45, 47 can alternately be introduced into the illumination beam path in order to realize illumination light with different spectral wavelength distributions.

The number of converter elements 45, 47 on the converter-element wheel 43 need not in this case correspond to the number of stops 39, 41 on the stop wheel 37. As a result of the separate arrangement of the stops and the converter elements on different wheels, there are particularly many combination options between stops and converter elements, and so a particularly flexible illumination device can be implemented.

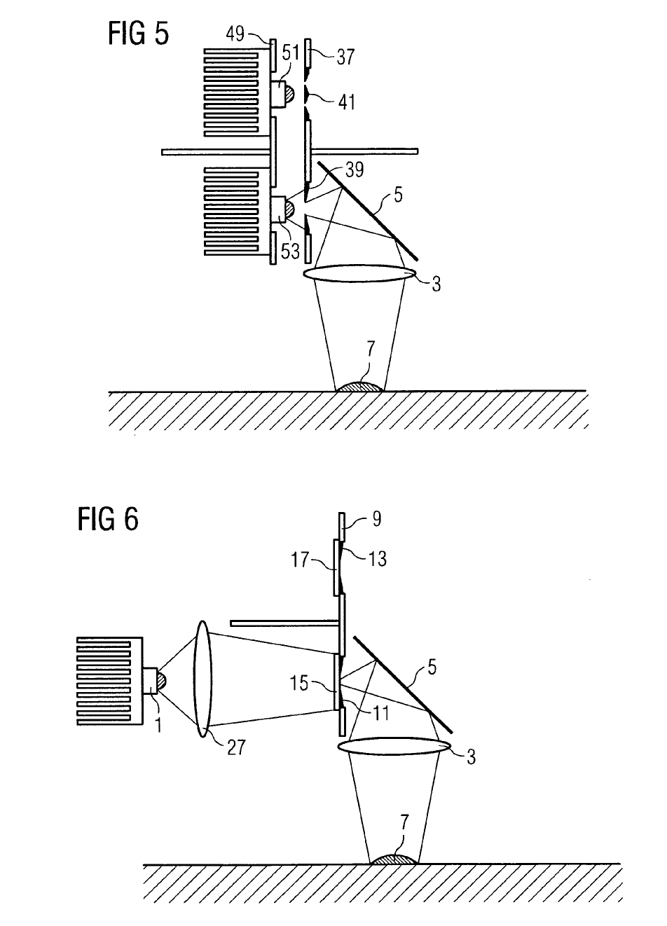

A fifth exemplary embodiment of the illumination device according to the invention is illustrated in FIG. 5. This exemplary embodiment differs from the exemplary embodiment illustrated in FIG. 4 in that there is an LED wheel 49 instead of the converter-element wheel 43. Arranged on said LED wheel there are arranged at least two light-emitting diodes 51, 53 which differ from one another in respect of the spectral wavelength distribution of the light emitted by them. The two light-emitting diodes 51, 53 can alternately be introduced into the illumination beam path with the aid of the light-emitting diode wheel 49. It goes without saying that the light-emitting diode wheel 49 can also have more than two light-emitting diodes. All light-emitting diodes arranged on the light-emitting diode wheel 49 preferably differ from one another in respect of the spectral wavelength distribution of the light emitted by them.

Since different colored light emitting light-emitting diodes are present as luminescence emitters in the exemplary embodiment illustrated in FIG. 5, it is possible to dispense with the use of converter elements. However, this exemplary embodiment is particularly flexible if additionally at least one converter element that can be introduced into the illumination beam path is present because this further increases the number of wavelength distributions that can be generated.

A sixth exemplary embodiment of the illumination device according to the invention is illustrated in FIG. 6. This exemplary embodiment is similar to the exemplary embodiment described with reference to FIG. 3 in such a way that use is made of an illumination device with an intermediate image, i.e. an illumination device with a collector optical system 27. The exemplary embodiment illustrated in FIG. 6 differs from the exemplary embodiment described with reference to FIG. 3 in that use is made of a stop wheel 9, as was also used in the first exemplary embodiment described with reference to FIG. 1. In the present exemplary embodiment, the stop wheel 9 is situated in the region of a plane conjugate to the object plane of the observation object 7, and so the stops 11, 13 of the stop wheel constitute radiant field stops. Additionally there may be an aperture stop, as illustrated in FIG. 3. Instead of at the location of a radiant field stop or in the vicinity of the location of a radiant field stop, the stop wheel can be arranged at the location of an aperture stop or in the vicinity of the location of an aperture stop. This also holds true for other exemplary embodiments in which use is made of a stop wheel.

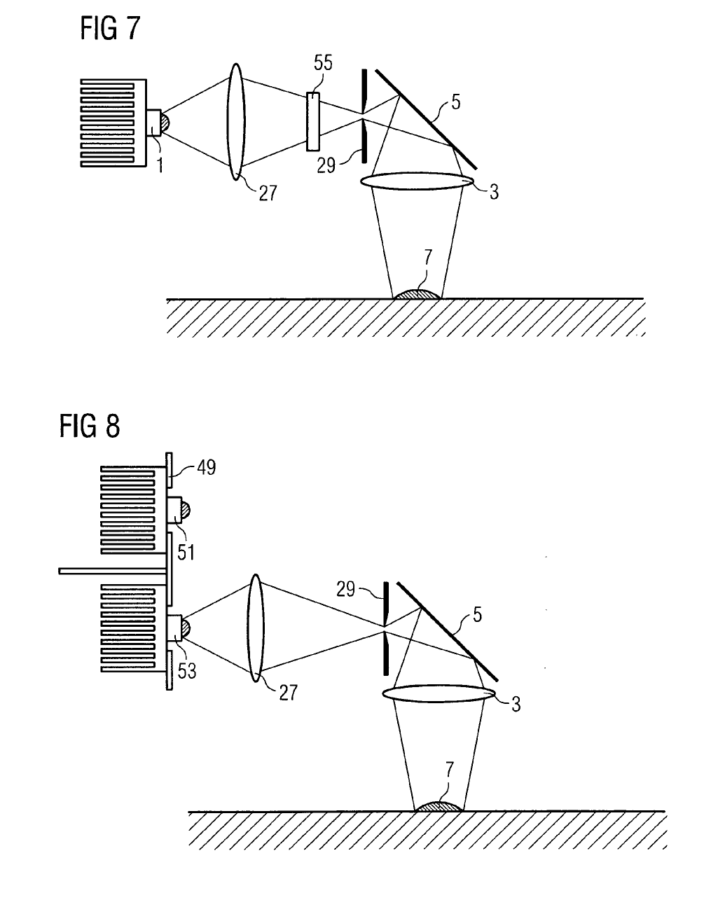

FIG. 7 shows a further exemplary embodiment of an illumination device according to the invention, in which there is an intermediate image of the light-emitting diode 1. The design of the illumination optical system corresponds to the design described with reference to FIG. 3, with the difference that there is no converter-element wheel. Rather, a converter element 55 is fixedly arranged in the illumination beam path of the observation device. The exemplary embodiment illustrated in FIG. 7 constitutes an exemplary embodiment for the device according to the invention with an intermediate image, having a particularly simple design.

A further exemplary embodiment of an illumination device with an intermediate image is illustrated in FIG. 8. This exemplary embodiment is similar to the third exemplary embodiment, described with reference to FIG. 3, except for the fact that instead of a single light-emitting diode 1 and a converter-element wheel 31, it is equipped with a light-emitting diode wheel 49 with at least two light-emitting diodes 51, 53, which differ from one another in respect of the spectral wavelength distribution of the light emitted by them. The light-emitting diodes 51, 53 can be alternately introduced into the illumination beam path with the aid of the light-emitting diode wheel 49. It goes without saying that the light-emitting diode wheel 49 can also have more than two light-emitting diodes 51, 53. However, additionally the exemplary embodiment illustrated in FIG. 8 may also have one or more converter elements that can be introduced into the beam path in order to further increase the number of possible spectral wavelength distributions of the illumination light.

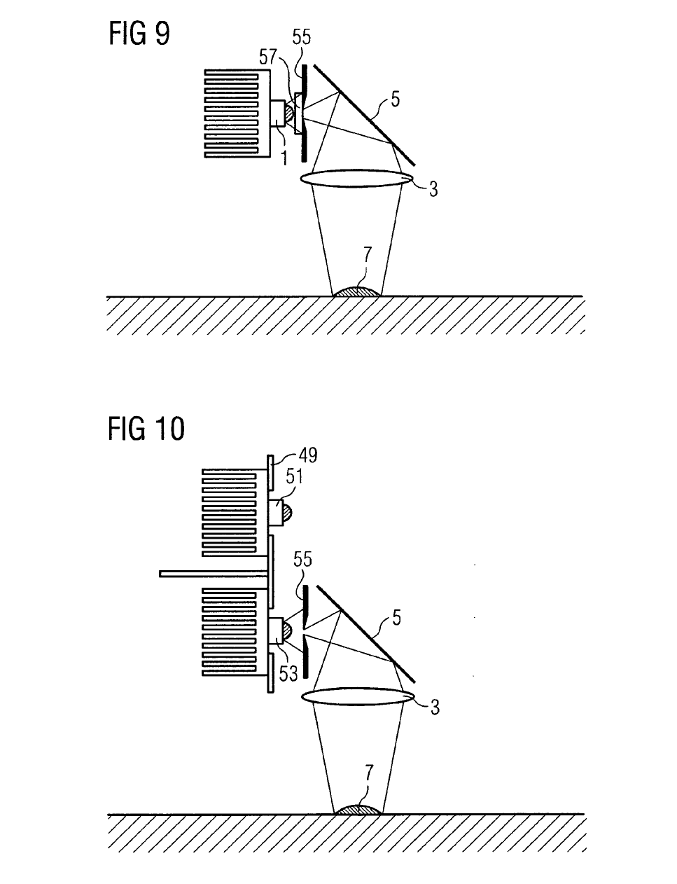

A further exemplary embodiment of an illumination device according to the invention without an intermediate image is illustrated in FIG. 9. This exemplary embodiment is similar to the first exemplary embodiment, described with reference to FIG. 1, except for the fact that instead of the stop wheel 9 with the stops 11, 13 and the converter elements 15, 17 a fixed radiant field stop 55, to which a converter element 57 is also attached, is arranged in the illumination beam path. The exemplary embodiment illustrated in FIG. 9 constitutes a particularly simply designed illumination optical system according to the invention.

A further exemplary embodiment for an illumination optical system according to the invention without an intermediate image is illustrated in FIG. 10. This exemplary embodiment also constitutes a modification of the exemplary embodiment described with reference to FIG. 1. Instead of the stop wheel 9 with stops 11, 13 and converter elements 15, 17 arranged thereon, there is a fixed stop like in the above-described ninth exemplary embodiment. However, in contrast to the ninth exemplary embodiment, no converter element 57 is arranged on the fixed radiant field stop. Instead, there is a light-emitting diode wheel 49, as was described with reference to FIG. 5. Said wheel comprises at least two light-emitting diodes 51, 53, which differ from one another in respect of the spectral wavelength distribution of the light emitted by them. The light-emitting diodes 51, 53 can be alternately introduced into the illumination beam path in order to implement different spectral wavelength distributions of the illumination light.

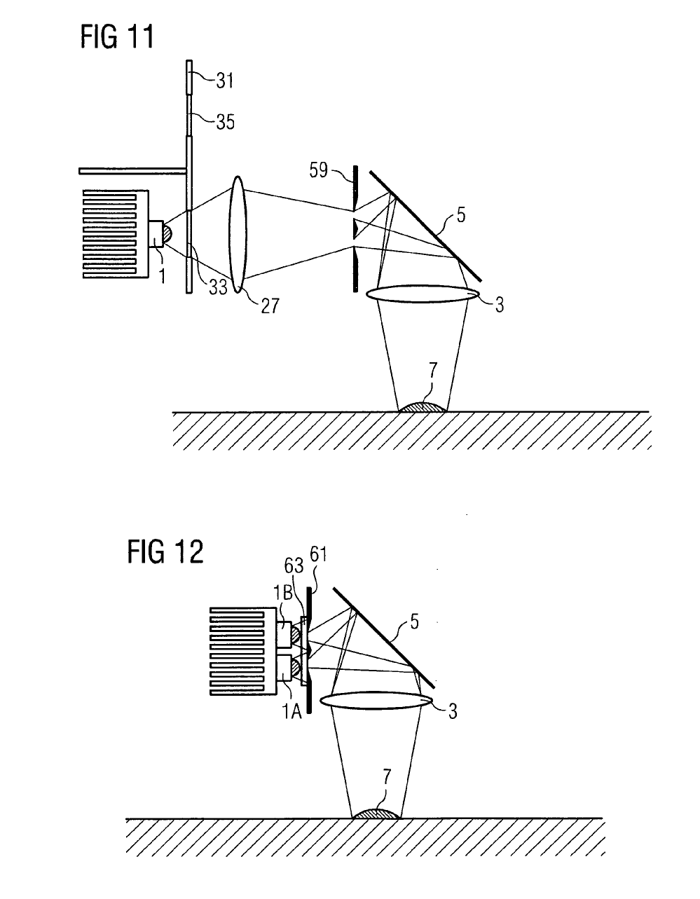

FIG. 11 shows a further exemplary embodiment for an illumination device according to the invention with an intermediate image. The exemplary embodiment merely differs from the exemplary embodiment shown in FIG. 3 in that, as an aperture stop, there is a double stop 59 with two stop openings instead of a single stop. The double stop 59 makes it possible to implement coaxial illumination.

A further exemplary embodiment of an illumination device according to the invention without an intermediate image is illustrated in FIG. 12. This exemplary embodiment is similar to the exemplary embodiment illustrated with reference to FIG. 9. However, instead of a single stop 55 with a converter element 57 arranged thereon, use is made in the twelfth exemplary embodiment of a double stop 61 with a converter element 63 arranged thereon as a radiant field stop. Moreover, there are two light-emitting diodes 1A, 1B which produce the illumination light as luminescence emitters. The arrangement described in FIG. 12 makes it possible to implement coaxial illumination.

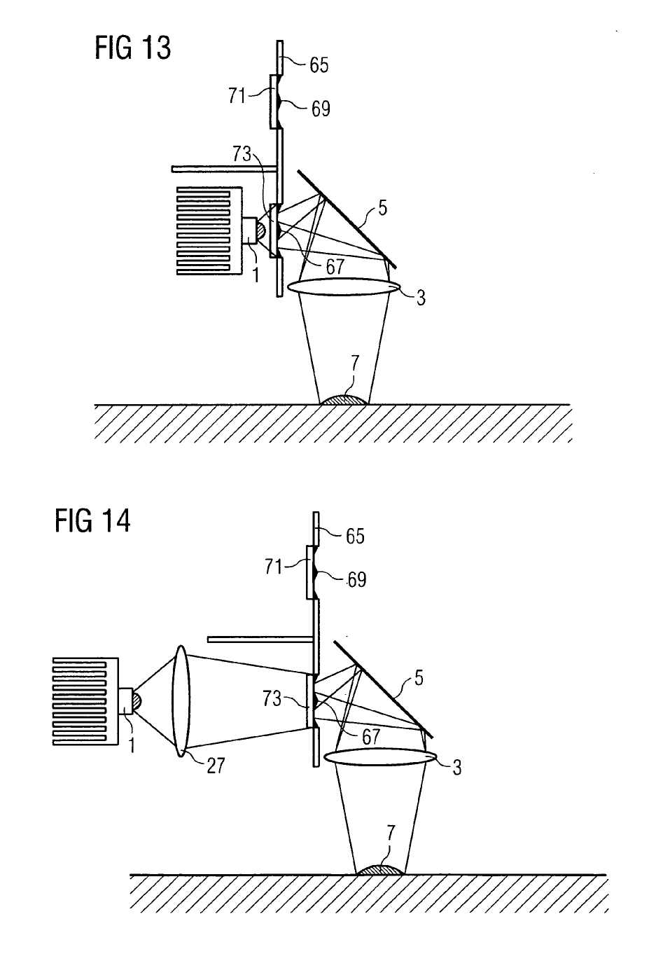

A further exemplary embodiment of an illumination device according to the invention without an intermediate image is illustrated in FIG. 13. In its design, this exemplary embodiment is similar to the first exemplary embodiment, described with reference to FIG. 1. The difference merely consists of the fact that instead of the stop wheel 9 with individual stops 11, 13 and converter elements 15, 17 arranged thereon, there is a stop wheel 65 with at least two double stops 67, 69 and, arranged upstream of the double stops 67, 69 in the beam path, converter elements 71, 73. This stop wheel 65 makes it possible to implement the already discussed coaxial illumination.

A further exemplary embodiment of an illumination device according to the invention with an intermediate image is illustrated in FIG. 14. This illumination device largely corresponds to the sixth exemplary embodiment, described with reference to FIG. 6, with the difference that the stop wheel 9 with the individual stops 11, 13 is replaced by a stop wheel 65, as was described with reference to FIG. 13. The double stops 67, 69 can be used to implement coaxial illumination beam paths.

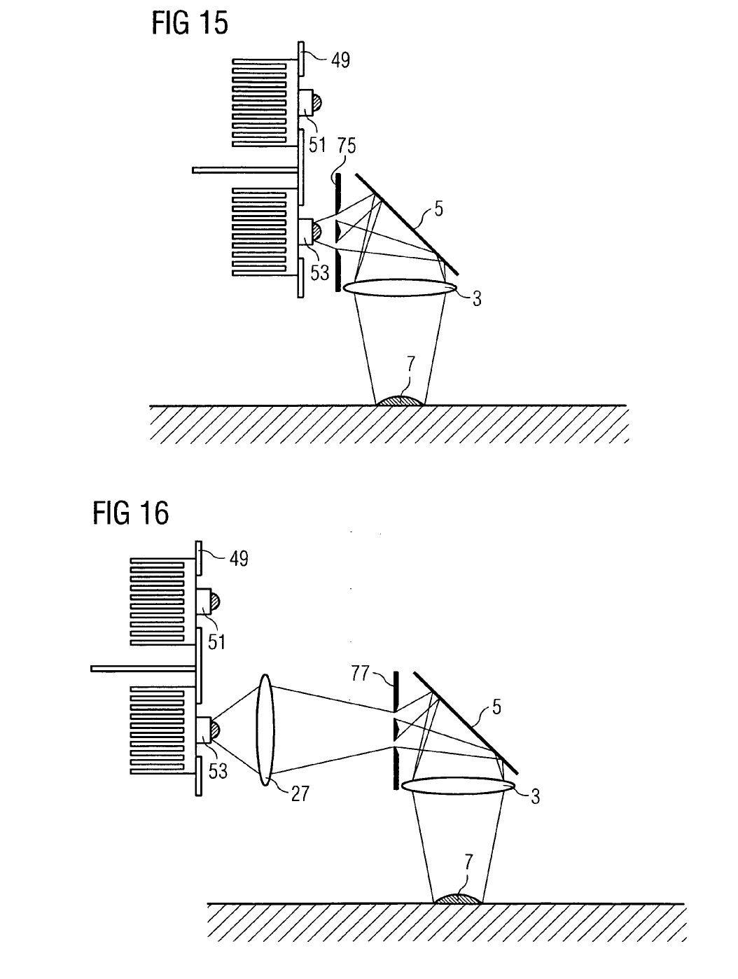

A further exemplary embodiment of an illumination device according to the invention without an intermediate image is illustrated in FIG. 15. This illumination device largely corresponds to the illumination device described with reference to FIG. 10, with the difference that instead of the single stop 55 there is a double stop 75, with the aid of which coaxial illumination can be implemented.

A further exemplary embodiment of an illumination device according to the invention with an intermediate image is illustrated in FIG. 16. This exemplary embodiment is similar to the exemplary embodiment shown in FIG. 8. However, the single stop 29 present in FIG. 8 is replaced by a double stop 77 in order to implement coaxial illumination. Otherwise the exemplary embodiment shown in FIG. 16 does not differ from the exemplary embodiment shown in FIG. 8.

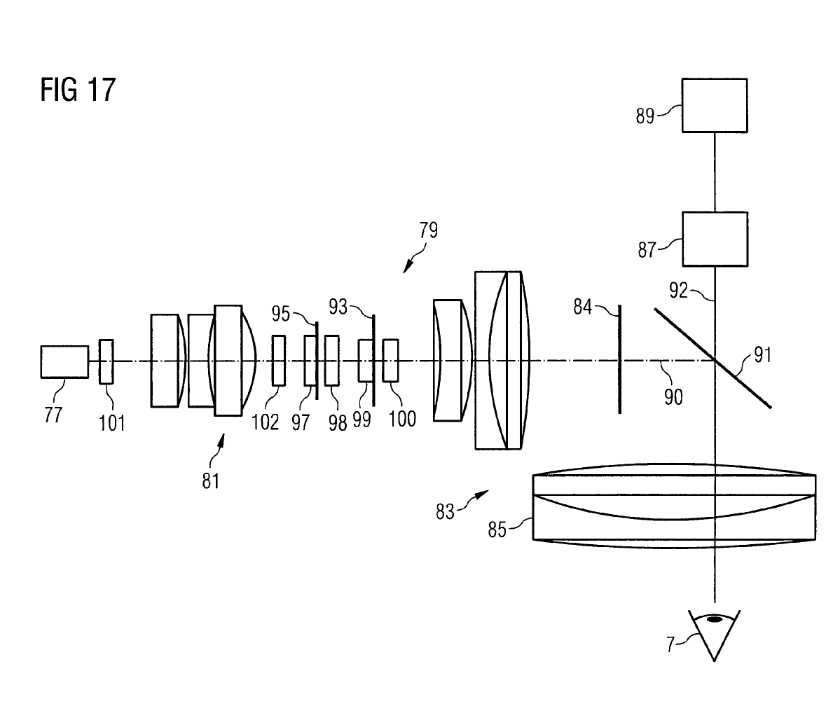

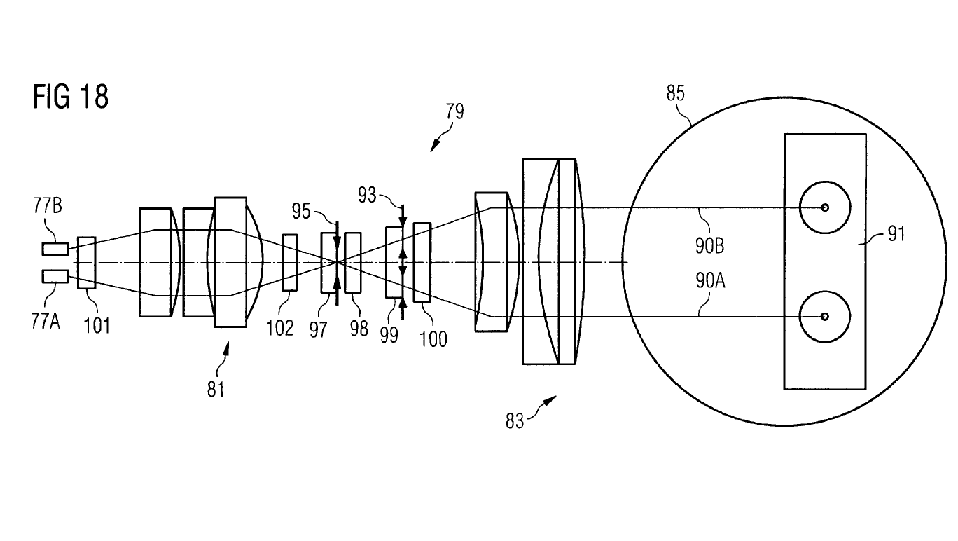

As an example of a medical-optical observation instrument with an illumination device according to the invention, a surgical microscope is illustrated in a schematic lateral view in FIG. 17 and in a schematic plan view in FIG. 18. In addition to two light-emitting diodes 77A, 77B or other luminescence emitters as light sources and an eye as an observation object 7, FIGS. 17 and 18 show an illumination optical system 79, which comprises a collector optical system 81 and a condenser optical system 83, the main objective 85 of the surgical microscope and—as functional blocks—a magnification-setting apparatus 87 and a binocular tube 89 of the surgical microscope.

The main objective 85 is primarily part of the observation optical system of the surgical microscope. However, since the illumination beam path 90 also passes through it in the present exemplary embodiment and thus contributes to projecting the illumination light onto the observation object 7, it can moreover be considered part of the illumination optical system 79.

In the present exemplary embodiment, both the collector optical system 81 and the condenser optical system 83 are made of lens groups in order to largely reduce image aberrations in the illumination beam path 90. The illumination beam path 90 is coupled into the main objective 85 via a beamsplitter 91, for example a partly transparent mirror, and routed to the observation object 7 via the main objective 85.

In addition to the illumination beam path 90 comprising the optical elements: collector 81, condenser 83, beamsplitter 91 and main objective 85, the surgical microscope has an observation beam path 92. The latter, starting from the observation object 7, runs through the main objective 85 and the beamsplitter 91, with, in contrast to the illumination beam path 90, the observation beam path 92 not being deflected by the beamsplitter 91. Moreover, a reflection stop 84 is arranged in the illumination beam path 90 on the light-source side of the beamsplitter 91, which reflection stop prevents reflections of the illumination being reflected into the observation beam path 92.

In the observation beam path 92, the magnification-setting apparatus 87 adjoins the beamsplitter 91; it makes it possible to set the magnification factor used to perform a magnification in the observation beam path 92. In particular, the magnification-setting apparatus 87 may be embodied as a zoom system, in which there are at least three lenses or lens groups, with two lenses or lens groups being displaceable along the optical axis such that the magnification factor can be set in a continuous fashion. Alternatively, it is also possible to embody the magnification-setting apparatus 87 as a discrete magnification changer. In the latter, there are a plurality of lens arrangements, with the lenses in a lens arrangement being fixed in a fixedly prescribed position with respect to one another. In such a discrete magnification changer, the magnification factor is changed by alternate introduction of different such lens arrangements into the observation beam path 92.

The magnification-setting apparatus 87 may already by embodied as a two-channel optical system, i.e. it has a left and a right stereoscopic partial beam path, with each partial beam path having its own optical elements. However, alternatively, the magnification-setting apparatus 87 may also be embodied as a so-called “large optical system”, i.e. the optical elements thereof are so large that both stereoscopic partial beam paths pass through them at the same time.

Then a purely optical or an optical/electronic binocular tube 89 adjoins the magnification-setting apparatus 87. In the case of a purely optical binocular tube 89, a tube objective and an eyepiece are arranged in each stereoscopic partial beam path. The tube objectives are used in each case to produce intermediate images in the stereoscopic partial beam paths, which intermediate images are imaged at infinity by means of the eyepiece optical system such that an observer can observe the intermediate images with a relaxed eye. In the case of a combined optical and electronic binocular tube 89, there is an imaging optical system in each stereoscopic partial beam path and it images the observation object 7 on two electronic image sensors.

In the present exemplary embodiment, the illumination device of the surgical microscope is embodied as so-called Köhler illumination. Here the light-emitting diodes 77A, 77B are imaged in an intermediate image plane in which there is an aperture stop 93, the latter being used to be able to set the brightness of the illumination in a targeted fashion. Furthermore, there is a radiant field stop 95, which is situated in the observation beam path 92 in a plane conjugate to the object pane of the observation object 7. Objects that are arranged in such a conjugate plane are imaged in a sharply defined fashion in the object plane. Hence the radiant field stop 95 can be used to implement a sharp delimitation of the illuminated field in the object 7. Overall, a Köhler optical system makes it possible to generate a sharply delimited homogeneous illuminated field in the object 7.

In terms of its basic design, the illumination optical system illustrated in FIGS. 17 and 18 corresponds to the illumination optical system described in DE 10 2006 013 761 A1, with the difference that two light-emitting diodes serve as light sources 77A, 77B instead of the optical fiber emergence end described in said document.

The illumination optical system 79 is embodied as a large optical system, i.e. both the partial beam path 90A starting at the light-emitting diode 77A and the partial beam path 90B starting at the light-emitting diode 77B pass through the collector optical system 81 and the condenser optical system 83 (see FIG. 18). Only the aperture stop 93 situated in the intermediate image plane of the illumination optical system 79 and the radiant field stop 95 situated in the plane conjugate to the object plane are embodied as double stops, i.e. they each have an individual stop opening for each partial beam path 90A, 90B of the illumination.

Blue light-emitting diodes are used as light-emitting diodes 77A, 77B in the present exemplary embodiment. In order nevertheless to be able to provide broad-band—and in particular white—illumination light, at least one converter element 97, 98, 99, 100, 101, 102 is introduced into the illumination beam path 90. Said converter element is preferably designed to be easily replaceable such that the spectral wavelength distribution in the illumination light can be changed by replacing the at least one converter element. Possible positions for arranging the at least one converter element 97, 98, 99, 100, 101, 102 are specified in FIGS. 17 and 18. It should be noted that the six converter elements 97 to 102 are merely sketched for characterizing the possible positions. Typically only one of the six sketched converter elements is present. In particular, it can be arranged in or in the vicinity of the radiant field stop 95, as indicated in FIGS. 17 and 18 by the converter elements 97 and 98.

The at least one converter element 97, 98, 99, 100, 101, 102 comprises a converter phosphor selected such that it converts at least part of the light from the light-emitting diodes 77A, 77B into light with a longer wavelength. In order to produce e.g. white light from the blue light of the light-emitting diodes 77A, 77B in the present exemplary embodiment, the converter phosphor of the converter element is selected such that it converts part of the blue light into yellow light such that the superposition of the yellow light on the remaining blue light yields white light. However, it may also be selected such that it converts all the light from the light-emitting diodes 77A, 77B into light of one or more longer wavelengths, particularly if the light-emitting diodes 77A, 77B emit light in the ultraviolet spectral range instead of light in the visible spectral range. In order to produce a broad wavelength distribution, the converter element can then comprise a mixture of a plurality of converter phosphors. However, alternatively it is also possible for at least two converter elements 97, 98, 99, 100, 101, 102 with different converter phosphors to be arranged in the illumination beam path 90. By way of example, in order to produce white light from the ultraviolet light, the ultraviolet light can partly or wholly be converted into blue light by a first converter element with a first converter phosphor. A second converter element with a second converter phosphor then converts the remaining ultraviolet light or part of the blue light into green light and/or yellow light and/or red light. The superposition of the blue light on the green light and/or the yellow light and/or the red light then yields broad-band light. More particularly, this can yield white light. Alternatively, use can also be made of merely a single converter element for producing the white light from the ultraviolet light, said converter element containing a mixture of the two converter phosphors.

The at least one converter element 97, 98, 99, 100, 101, 102 can moreover have an entry area which faces the light-emitting diodes 77A, 77B and is provided with a dichroic layer that is transparent to light with the wavelength distribution of the unconverted light entering the converter element 97, 98, 99, 100, 101, 102. By contrast, this dichroic layer is highly reflective for converted light directed in the direction of the light-emitting diodes 77A, 77B. This can increase the efficiency of the conversion. Such a dichroic layer may also be present in the converter elements in the other exemplary embodiments.

1. An illumination device for a medical-optical observation instrument for illuminating an observation object (7) with illumination light via an illumination beam path (90), the illumination device comprising: at least one luminescence emitter (1, 51, 53, 77) as a light source, and at least one converter element (15, 17, 23, 25, 33, 35, 45, 47, 57, 63, 71, 73, 97-102) is arranged separately from the luminescence emitter (1, 51, 53, 77) and provided with a converter phosphor for converting at least part of the wavelength distribution of the light emitted by the at least one luminescence emitter (1, 51, 53, 77), and the at least one converter element is or can be introduced into the illumination beam path (90) and the at least one converter element includes a converter element (97) that is or can be introduced into the illumination beam path (90) in a plane conjugate to the object plane.

2. The illumination device as claimed in claim 1, characterized in that it comprises a condenser optical system (3, 38) and the converter element (15, 17, 23, 25, 33, 35, 45, 47, 57, 63, 71, 73, 97-102) is or can be introduced into the illumination beam path (90) between the luminescence emitter (1, 51, 53, 77) and the condenser optical system (3, 83).

3. The illumination device as claimed in claim 2, characterized in that it comprises a collector optical system (27, 81) arranged between the luminescence emitter (1, 51, 53, 77) and the condenser optical system (3, 83), and the converter element (15, 17, 57, 71, 73, 97-100, 102) is or can be introduced into the illumination beam path (90) between the collector optical system (27, 81) and the condenser optical system (3, 83).

4. The illumination device as claimed in claim 1, characterized in that the converter element (15, 17, 63, 71, 73, 97, 99) is part of a stop (11, 13, 55, 61, 67, 69, 93, 95) that is or can be introduced into the illumination beam path.

5. The illumination device as claimed in claim 4, characterized in that the converter element (97) is part of a radiant field stop (95).

6. (canceled)

7. The illumination device as claimed in claim 3, characterized in that the converter element (98) is or can be introduced into the illumination beam path (90) directly in front of or behind a plane conjugate to the object plane.

8. The illumination device as claimed in claim 3, characterized in that the converter element (99) is or can be introduced into the illumination beam path (90) in a plane conjugate to the plane of the illuminated area of the luminescence emitter (77).

9. The illumination device as claimed in claim 4, characterized in that the converter element (99) is part of an aperture stop (93).

10. The illumination device as claimed in claim 3, characterized in that the converter element (100) is or can be introduced into the illumination beam path (90) directly in front of or behind a plane conjugate to the illuminated area of the luminescence emitter (77).

11. The illumination device as claimed in claim 3, characterized in that the converter element (33, 35, 101) is or can be introduced into the illumination beam path (90) between the luminescence emitter (1, 77) and the collector optical system (27, 81).

12. The illumination device as claimed in claim 10, characterized in that the converter element (33, 35, 101) is or can be introduced into the illumination beam path (90) directly adjacent to the illuminated area of the luminescence emitter (1, 77).

13. The illumination device as claimed in one of claim 1, characterized in that the at least one converter element has an entry area for the illumination light emitted by the luminescence emitter (1, 51, 53, 77), which entry area faces the luminescence emitter (1, 51, 53, 77) and is provided with a dichroic layer that is transparent to unconverted light entering the converter element and is highly reflective for converted light directed in the direction of the luminescence emitter (1, 51, 53, 77).

14. The illumination device as claimed in claim 1, characterized in that there are at least two converter elements (15, 17, 23, 25, 33, 35, 45, 47, 71, 73, 97-102) that can, individually or together, be introduced into the illumination beam path (90).

15. An illumination device for a medical-optical observation instrument for illuminating an observation object (7) via an illumination beam path (90), which illumination device comprises at least one luminescence emitter (1A) as a light source, more particularly the illumination device as claimed in claim 1 characterized in that there is at least one second luminescence emitter (1B), which can be introduced into the illumination beam path (90) instead of the first luminescence emitter (1A) and the light of which has a spectral wavelength distribution that differs from the spectral wavelength distribution of the light emitted by the first luminescence emitter (1A).

16. A medical-optical observation instrument with an illumination device as claimed in claim 1.
